(19) United States
(12) Patent Application Publication
(10) Pub. No.: US 2025/0383539 A1
(43) Pub. Date: Dec. 18, 2025

(54) KALEIDOSCOPIC GEOMETRIC VISION PLATFORM

(71) Applicant: Summer Robotics, Inc., Campbell, CA (US)

(72) Inventor: Gerard Dirk Smits, Los Gatos, CA (US)

(21) Appl. No.: 19/242,542

(22) Filed: Jun. 18, 2025

Related U.S. Application Data
(60) Provisional application No. 63/731,871, filed on Jun. 18, 2024.
(60) Provisional application No. 63/732,563, filed on Aug. 29, 2024.

(51) Int. Cl. G02B 26/12; H04N 13/243; H04N 25/47

(52) U.S. Cl. CPC G02B 26/123; G02B 26/122; G02B 26/125; H04N 13/243; H04N 25/47

(57) ABSTRACT

A Kaleidoscopic Geometric Vision Platform (KGVP) that transforms three-dimensional (3D) machine vision through an optical system that creates multiple virtual laser projectors from a single moving component. A spindle mirror mechanism (SMM) rotates a reflective surface to sweep collimated laser beams in circular patterns. These beams strike a series of kaleidoscopic mirror facets (KMFs) arranged concentrically around the SMM in a concave configuration. Each KMF redirects the rotating beam, creating a virtual projector with a distinct origin point and sweep direction. As the SMM completes one rotation, it generates N distinct laser trajectories (where N equals the number of KMFs), each sweeping from a different virtual origin point. Event-based cameras/sensors positioned strategically around the KMFs detect laser light reflected from object surfaces with microsecond precision. The KGVP triangulates 3D surface coordinates by determining correspondence between detected light and specific virtual projectors based on precise timing information.

### CROSS-REFERENCE TO RELATED APPLICATION

This application is a Utility Patent application based on previously filed U.S. Provisional Patent Application U.S. Ser. No. 63/731,871 filed on Jun. 18, 2024, and U.S. Provisional Patent Application U.S. Ser. No. 63/732,563 filed on Aug. 29, 2024, the benefit of the filing date of which is hereby claimed under 35 U.S.C. § 119(e), and the contents of each application is incorporated herein expressly by reference.

### TECHNICAL FIELD

The present innovations relate generally to a system for projecting a sweeping pattern of laser beams. The pattern is swept in a diversity of directions by a plurality of reflective facets and a diversity of laser beam emission apertures.

### BACKGROUND

Historically, robot vision platforms have projected sweeping patterns of laser beams with projector devices that employ several moving structures having a diversity of direction and a diversity of laser beam emission apertures. However, the usage of these projector devices was often limited by several factors for use with only a few types of applications that could most benefit from the projection of highly diverse laser beam patterns. These factors typically included cost, mechanical reliability, complexity, energy consumption and physical size.

Thus, there is an opportunity to mitigate these substantially limiting factors for projector devices that are significantly less complex and employ as few as one moving structure to emit a plurality of diverse laser beam patterns.

### BRIEF DESCRIPTION OF THE DRAWINGS

Non-limiting and non-exhaustive embodiments of the present innovations are described with reference to the following drawings. In the drawings, like reference numerals refer to like parts throughout the various figures unless otherwise specified. For a better understanding of the described innovations, reference will be made to the following Detailed Description of Various Embodiments, which is to be read in association with the accompanying drawings, wherein:

FIG. 1 shows an embodiment of a system overview for an exemplary kaleidoscopic geometric vision platform (KGVP);

FIG. 2 illustrates a top view of an exemplary “4×1” scanning system with an eight-sided octagonal shaped reflector for a kaleidoscopic projector device;

FIG. 3 shows an exemplary side view of a diagonal cross-sectional side view of a kaleidoscopic projector device where a South East laser beam stroke and a North West laser beam stroke are seen by a diagonal pair of cameras C₂ and C₄ having a base line separation of approximately eight inches;

FIG. 4 illustrates an exemplary top view of a “4×1” scanning system projecting successive laser strokes in eight different “compass” directions for a kaleidoscopic projector device;

FIG. 5 shows a top cross sectional view of an exemplary “3×1” scanning system that includes three cameras and a hexagonal shaped reflector for a kaleidoscopic projector device;

FIG. 6 illustrates a top view of an exemplary “4×1” scanning system that includes a rectangular shaped reflector to project four laser beam strokes by a kaleidoscopic projector device;

FIG. 7 shows a top view of another exemplary “4×1” scanning system with alternative “Inside/outside” placement of four cameras for a kaleidoscopic projector device;

FIG. 8 illustrates a top view of an exemplary beam splitting dual layer concentric kaleidoscopic projector device;

FIG. 9 shows a side view of an exemplary folding up of the view provided to a single camera;

FIG. 10 illustrates a side view of a stereoscopic (two-view) scanning system with a single event sensor and dual apertures;

FIG. 11 shows a side view of an exemplary stereoscopic (two-view) scanning system with a single event sensor, single aperture, dual folded optics to enable a doubling of the resolution;

FIG. 12 illustrates side and top views of an exemplary ultra compact scanning system for a kaleidoscopic projector device;

FIG. 13 shows an embodiment of a side view of a scanning system for an exemplary kaleidoscopic geometric vision platform (KGVP);

FIG. 14 illustrates an exemplary spinning mirror that is arranged for positioning within a spindle mirror mechanism (SMM) to reflect a plurality of simultaneous crossing (concurrent) scan trajectories of laser beams on surfaces of objects in a field of view of the KGVP;

FIG. 15 shows a “Hinged Petals”, a side view of one of a plurality of hinged flutter mirrors in an SMM;

FIG. 16A illustrates an exemplary look up table (LUT) which holds pre calculated relative values for an expected accuracy for laser beams of each of M virtual projectors when paired with each of N sensors which is determined by each baseline separation between any one pair of virtual projection origins Oₘ′ and Cₙ.

FIG. 16B shows an exemplary octagonal 4×1 KGVP with corresponding relative values represented in the LUT of FIG. 16A, where the relative values range from a maximum of 5.3 (5.3″ baseline) to a minimum of 0.8. An optimal Rx-Tx triangulation result from the reflected light of scanned beams may be observed from their diagonally opposed cameras as four such “optimal” pairs represented in the LUT;

FIG. 16C illustrates an exemplary LUT with the relative values for a 4×1 KGVP showing equivalent quality values for six pairs of cameras;

FIG. 17 shows an exemplary triangular (“3×1”) KGVP for ensuring a maximal Rx-Tx disparity and having three distinct and separate camera-projector (Rx-Tx) pairs to operate and scan a field of view simultaneously using a single projector;

FIG. 18A illustrates a hinged dual flutter mirror for a KGVP to inhibit reflection of incident scanned laser beams when the hinged flutter mirror is not spinning;

FIG. 18B shows reflection of the scanned laser beams when a hinged dual flutter mirror for a KGVP is spinning/rotating fast enough for the reflected laser beams to not be incident on a kaleidoscopic mirror facet as an eye safety feature;

FIG. 19 illustrates exemplary guidance of a laser tool with a KGVP operating actively for positioning of the laser toll, such as a laser drill or ablation tool precisely in reference to three dimensional (3D) features on a work piece;

FIG. 20 shows an exemplary irregular shaped arrangement of kaleidoscopic mirror facets (KMFs) that may be rotated and translated to create a wider scan coverage;

FIG. 21 illustrates a 4×1 KGVP (top view) where four of the Kaleidoscopic Mirror Facets (KMFs) (1, 3, 5 & 7) are set back from a center of a spindle mirror mechanism (SMM) and the other four KMFs (2, 4, 6 & 8) are rotated by a small angle +β or −β;

FIG. 22 shows a flow chart for an embodiment of a process for performing the actions of the KGVP system; and

FIG. 23 illustrates a flow chart for an embodiment of a process for accurately and efficiently triangulating points in a spatial environment.

### DETAILED DESCRIPTION OF VARIOUS EMBODIMENTS

Various embodiments now will be described more fully hereinafter with reference to the accompanying drawings, which form a part hereof, and which show, by way of illustration, specific exemplary embodiments by which the invention may be practiced. The embodiments may, however, be embodied in many different forms and should not be construed as limited to the embodiments set forth herein; rather, these embodiments are provided so that this disclosure will be thorough and complete, and will fully convey the scope of the embodiments to those skilled in the art. Among other things, the various embodiments may be methods, systems, media or devices. Accordingly, the various embodiments may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

Briefly, the kaleidoscopic geometric vision platform (KGVP) enables projection and detection of sweeping patterns of laser beams generated by reflective facets and diverse emission apertures. A spindle mirror mechanism (SMM) is arranged to rotate and reflect collimated laser beams across a kaleidoscopic mirror having multiple facets (KMFs). In this way, each KMF creates a virtual projection of a reflected laser beam from its own origin point and scan direction.

In one or more embodiments, multiple types of configurations may be arranged for the KGVP, including: (1) a 4×1 Octagonal KGVP with an eight sided kaleidoscopic mirror (8 KMFs) with four event cameras positioned behind the facets, which creates eight distinct laser beam strokes in different compass directions; (2) a 3×1 hexagonal KGVP with a six sided kaleidoscopic mirror (6 KMFs) with three cameras to create six distinct laser beam strokes at 60 degree intervals; (3) a 4×1 rectangular KGVP with a four sided kaleidoscopic mirror (4 KMFs) with four cameras behind the facets to create four distinct laser beam strokes with proportional stroke durations; (4) an irregular shaped KGVP with a non-uniform shaped kaleidoscopic mirror (multiple non-uniform KMFs) that is arranged to cover a wider area with distinct laser beam strokes.

In one or more other embodiments, multiple types of enhancements to the arrangement/configuration of the surfaces/facets of a kaleidoscopic mirror/reflector for the KGVP may include: (1) a beam splitting dual layer concentric kaleidoscopic mirror having an inner ring of partially transparent mirrored facets/surfaces with an outer ring of mirrored facets/surfaces redirecting distinct laser beam strokes: (2) a hinged dual flutter kaleidoscopic mirror/reflector with multiple surfaces/facets that change their angle during rotation, using centrifugal force which can improve safety; (3) a hinged petal flutter kaleidoscopic mirror/reflector with multiple oblong “petal” shaped surfaces/facets mounted on hinges at an axis of a spindle mirror mechanism.

In one or more embodiments, multiple types of enhancements to the arrangement/configuration of a view for the KGVP may include: (1) a view folding arrangement that doubles a field of view of a camera using half mirrors/reflective surfaces to capture multiple perspectives; (2) an ultra-compact stereo scanning arrangement that uses a single camera/sensor having dual apertures and mirror relays to capture stereoscopic views; and (3) a multi-perspective triangulation arrangement that employs look-up tables (LUTs) to improve accuracy with optimized pairings of cameras/sensors to swipes of the laser beam projections.

In one or more embodiments, safety and control features for the arrangement/configuration of the KGVP may include: (1) a diffractive optical element (DOE) may be provided to prevent beam reflection when the KMFs aren't spinning at an operational speed; and (2) a speed based safety control to ensure that the laser beams are only scanned when a spindle mirror mechanism rotates within specific speed thresholds.

In one or more embodiments, various applications of the KGVP may include: (1) a precision tool guidance feature to actively position one or more laser drills and/or ablation tools using real time three dimensional laser beam scanning information; (2) a three-dimensional metrology that employs multiple perspective views to ensure gap and flushness measurements are optimal; and (3) a complex surface scanning feature to enhance coverage of complex three-dimensional structures through diverse beam angles and camera/sensor perspectives.

In one or more embodiments, calibration systems for the KGVP may include: (1) a self-calibrating feature that uses event data from multiple calibration cycles to precisely measure angles and positions; and (2) a look up table (LUT) that includes precalculated relative values for expected accuracy between virtual projectors and cameras/event sensors.

In one or more embodiments, the KGVP provides the benefits of multiple projectors while using a single moving mechanism, offering increased precision, reduced mechanical complexity, and improved energy efficiency compared to traditional vision platforms often used for robotic systems.

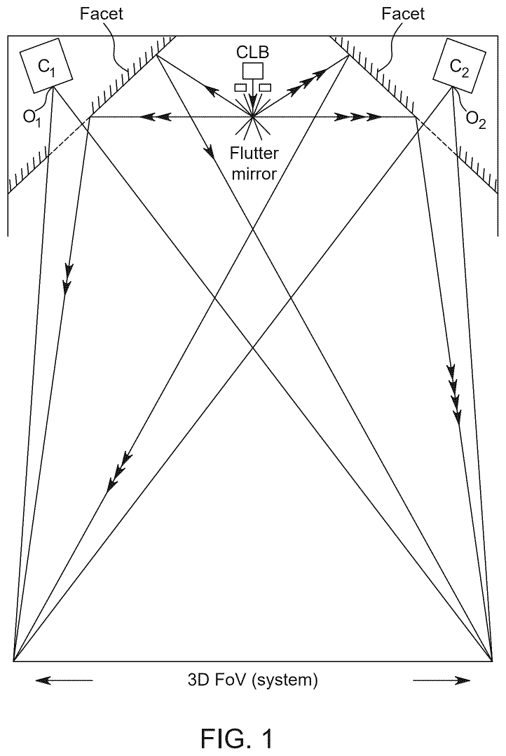

FIG. 1 shows an embodiment of a system overview for an exemplary kaleidoscopic geometric vision platform (KGVP). As shown in FIG. 1, a collimated Laser Beam (CLB) may be swept/reflected by a spindle mirror (SM). Further, the reflected laser beam rotates from a single central point of origin (O_{SM}). Also, N Kaleidoscopic mirror facets are arranged in a concave configuration around the spindle mirror. Typically, N is 4 or greater. These kaleidoscopic facet mirrors reflect, redirect and subdivide the rotating beam's trajectory into new fractional sub-trajectories. Each 360-degree rotation of the spindle mirror results in N distinct laser scan trajectories, each time rotating the beam over an angle that is a fraction, 360/N degrees, and each beam sweeping from a new virtual (apparent) point of origin O′₁, O′₂, . . . to O′_{N}. Thus, N virtual projectors are created, each sweeping a beam from its associated point of origin, O′, a fixed location in 3D space, that is a reflection of the spindle mirror center of rotation (OTₓ) mirrored by one of the N facets in the Kaleidoscopic mirror.

Furthermore, exact locations in 3D space can be found by calibration of a system using methods such as described in U.S. patent application Ser. No. 18/671,625 filed on May 22, 2024 and entitled “Calibration of Scanning 3-D perception systems”; and further described in U.S. patent application Ser. No. 19/203,054 entitled “Kaleidoscopic Sweeping Laser Beam Projection System” that was filed on May 8, 2025. Both of the '625 and '054 patent applications are herein incorporated by reference in regard to their exemplary calibration methods for a system.

Additionally, the motion of a laser spot on a surface of an object may be entirely due to the rotation of the beam effected by the rotation of the spindle mirror. Its sweep direction may be affected by the mirror facet, but its rotational (angular) velocity (ω) may not be. Thus, each of the sweeping laser beam patterns observed can be substantially identical in speed (angular sweep progression, or ω) and differ in just sweep direction (2 DoF), and the spatial position of the virtual origin (3 DoF).

Moreover, when the Kaleidoscopic mirror is comprised of a regular polygon, such as a 4-sided pyramid, 5-sided regular pentagon or 6-sided regular hexagon, or an 8-sided regular polygon, then the projector and its projection patterns can reflect the essential rotational symmetry of these geometric, faceted mirror shapes. From these examples, it follows that in these regular N polygon kaleidoscopic projection systems the N Virtual Optical Origins (O′₁, O′₂, . . . O′_{N}), it may also follow the same rotational symmetry. (i.e. they would form a square, pentagon, hexagon or an octagon respectively).

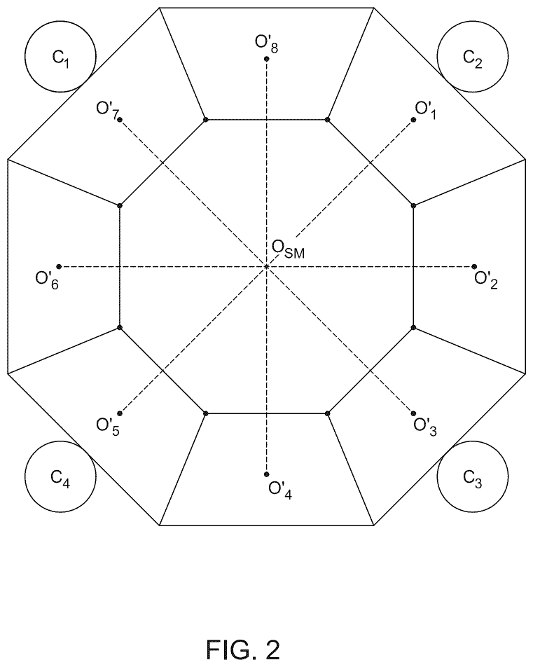

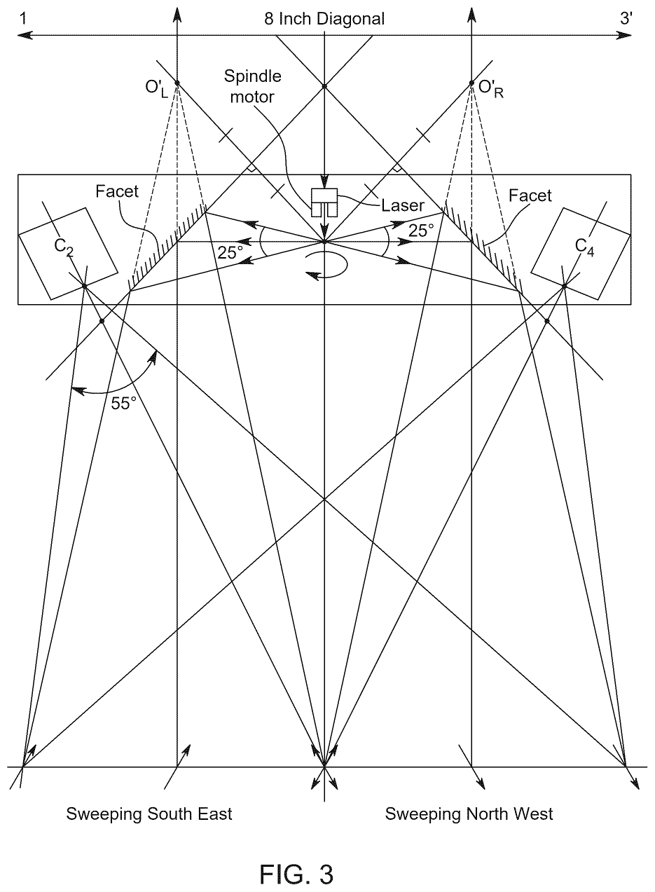

FIG. 2 illustrates a top view of an exemplary “4×1” scanning system with an eight-sided octagonal shaped reflector for a kaleidoscopic projector device. A collimated laser beam (CLB) impinges precisely at the center of an oval shaped spindle mirror (SM) which is angled at a 45-degree offset from its spindle motor axis. Thus, the beam is redirected by an angle of 90 degrees, from its vertical concentric alignment with the spindle motor axis, and can sweep around in a horizontal circular sweep pattern.

Further, each of the eight Octagonal Kaleidoscopic mirror facets redirects the outward sweeping laser beam downwards by approx. 90 degrees. In this exemplary system the actual redirection would be 90 degrees at the center of each of the eight facets but fanning out a little more than that, to approx. 100 degrees when the beam reaches the edge of one facet, and transitions to the next facet.

As shown, FIG. 2 shows the top view of the system. In one or more of the exemplary embodiments, when the spindle mirror is spinning clockwise, at 1500 RPM, so that the mirror makes a full 360-degree rotation in 40 milliseconds, the scanning across each of the eight kaleidoscopic mirror facets in five milliseconds. Also, the cameras C₁, C₂, C₃ and C₄ could be mounted in the four corners of the system, fitted behind four of the kaleidoscopic mirror facets. The camera's optical centers form a square with a size of approximately 5.6 inches base line separation between any pair of cameras (C₁-C₂, C₂-C₃, C₃-C₄ and C₄-C₁), and approx. 8 inches separation between the pairs that form the diagonal (C₁-C₃ and C₂-C₄). Note: in this example all dimensions are arbitrary: lengths in inches, angles in degrees, and time in milliseconds.

In this nominal example, when the laser beam sweeps, e.g. across the Northeast facet rotating 45 degrees, the laser beam can reflect off the facet and it will appear as if the point of rotation is at the virtual origin O₁′ which lies approx. 2.75 inches above that facet's center. Similarly, when the laser beam sweeps across the other seven facets of the kaleidoscopic mirror, the reflected light can appear to originate from seven more virtual origins O′₂, O′₃, . . . O′₈. Note that the virtual origins themselves also form a regular octagon.

In the case of the first stroke across the Northeast Facet, this can result in a flying spot trajectory on a surface below our scan system that spans approx. 45 degrees, or about 6 inches long at approx. 4.4 inches below or about 7.25 inches below the virtual origin O₁′. A 45-degree sweep trajectory of approximately 6 inches across a surface 7.25 inches away takes 5 milliseconds. Assuming Camera C₂ directly behind the Northeast facet is oriented in landscape mode, then C₂ may observe this stroke cross diagonally across approx. 700 rows and 700 columns. Thus, this trajectory traverses across each row in approx. 7 microseconds. (5 milliseconds/700 rows). The actual instantaneous linear speed slows to a minimum in the middle of this trajectory, and is slightly faster at both the beginning and end of the trajectory due to the radial distance between O₁′ and a flat surface is greater at both extremes and minimal at the center.

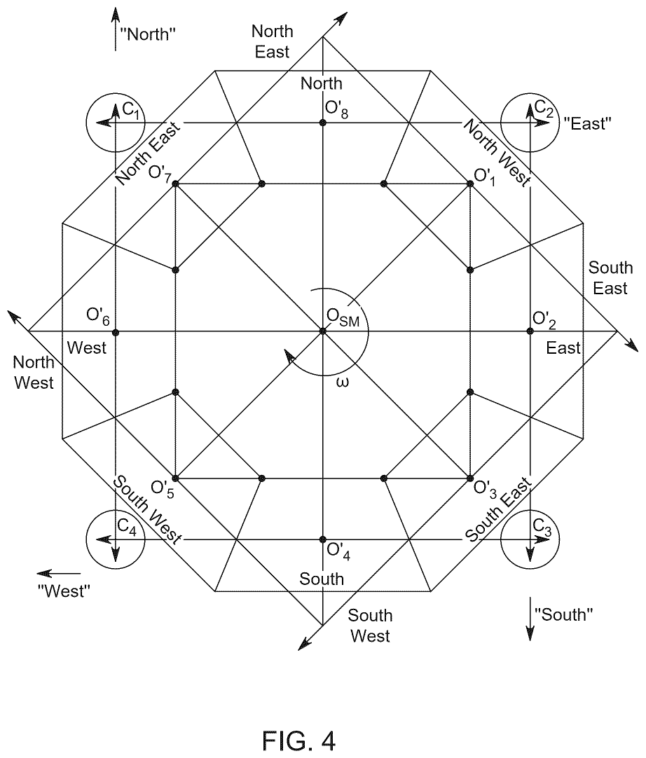

Due to the radial symmetry of the system, each successive stroke will be exactly the same in its progression, and only different in its apparent origin and sweep direction. Eight strokes around the compass. (See FIG. 4)

The first stroke reflects for 5 milliseconds off the Northeast facet, resulting in a laser beam that appears to pivot over 45 degrees at O₁′ in a Southeastward sweep direction.

The second stroke reflects for 5 milliseconds off the East facet, resulting in a laser beam that appears to pivot at O₂′ in a Southward sweep direction.

The third stroke reflects for 5 milliseconds off the Southeast facet, resulting in a laser beam that appears to pivot at O₃′ in a Southwestward sweep direction.

The fourth stroke reflects for 5 milliseconds off the South facet, resulting in a laser beam that appears to pivot at O₄′ in a Westward sweep direction.

The fifth stroke reflects for 5 milliseconds off the Southwest facet, resulting in a laser beam that appears to pivot at O₅′ in a Northwestward sweep direction.

The sixth stroke reflects for 5 milliseconds off the West facet, resulting in a laser beam that appears to pivot at O₆′ in a Northward sweep direction.

The seventh stroke reflects for 5 milliseconds off the Northwest facet, resulting in a laser beam that appears to pivot at O₇′ in a Northeastward sweep direction.

The eighth stroke reflects for 5 milliseconds off the North facet, resulting in a laser beam that appears to pivot at O₈′ in an Eastward sweep direction.

What is notable is that as the spindle mirror makes one full rotation in 40 milliseconds (i.e. at repetition rate of 25 Hz, at a spindle motor speed of 1500 RPM), when projecting these scanning lasers on a planar surface, for e.g. calibration, these 8 consecutive strokes will generate a minimum of 1400 events per stroke, assuming the beam stimulates a path that is 2 pixel events wide, that is: 11,200 events in the 40 milliseconds it will take the spindle mirror to swing a beam around the kaleidoscopic mirror.

In the 4×1 there are 4 event sensors so during calibration the pattern of a single laser on a calibration target that can be seen by each sensor, with one revolution of the spindle mirror in will generate 44,800 events in 8 successive strokes in 40 milliseconds. So, in one second of calibration after 25 revolutions more than a million events are generated. Even at a modest speed, with just one laser, each second yields more than a million events with microsecond resolution. That is a wealth of calibration data enabling a very precise almost instant estimation of exact origins and of the periodic sweep motion trajectories of these 8 virtual projectors. 25 repeat observations of each individual projector's sweep pattern, 140,000 motion datapoints on each of the 8 virtual projectors.

Generally, it is best to start calibration with modest event rates to ensure the highest time stamp fidelity. Minimizing lag and jitter ensures the most accurate calibration result. The most state-of-the-art event cameras have a central arbiter that assigns timestamps to asserted event pixels. There is a limit on how many timestamps the arbiter can process in real time. When the event rate exceeds a certain level the arbiter may become overloaded and the central arbiter circuit can fall behind in assigning timestamps. This results in incorrect (i.e. late, randomly erroneous) timestamps. At excessively high event rates, event time lag errors can grow to 10 microseconds or more, as significant time will elapse between the actual time the pixel analog circuits detected photons impinging on its photo diode (instantly resulting in an increase in photo electron current) and the time when this event is recorded (assigned time stamp) by the central arbiter logic.

Consequently, to reach an optimal calibration, the total event rate should be kept below one million raw events per second per camera in the following ways:
1. Use narrow band pass filters or a light blocking enclosure or shroud to block extraneous light sources that might otherwise stimulate random events.
2 A good way to test for the presence of ambient light interference is to run the system with the cameras on, but with the lasers off, and to observe the random events rate, to determine whether it is below an acceptable maximum. More than a 100,000 events/sec in any camera would be high and would merit adjusting the event camera pixel bias settings and inspecting for ambient light sources that might be causing this.
3. Choose pixel bias settings that avoid excessively “trigger happy” pixels.
4. Make sure that the calibration target is positioned at the focal plane of the cameras. Adjust the individual camera's focus if needed or move the calibration target.
5. Make sure that the laser spot is minimal, meaning that the laser trajectories are about 2 pixels wide.
6. Avoid excessive laser power. Use a calibration target with a sufficiently low albedo.
7. Choose a low rotations per minute (RPM), so that the pixel transit time is 7 microseconds or longer.
8. If there are multiple lasers that can be individually selected (turned on and off), choose the one that yields the best continuous (unbroken) event stream for each of the N strokes, as the spindle mirror turns.
9. If the system uses a diffractive optical element (DOE) to split one laser source into a multiple of sub beams, then choose a low enough RPM (spindle motor speed) and select the one sub beam that yields the best continuous (unbroken) event streams for each of the N strokes, as the spindle mirror turns.

Thus, for one or more embodiments, to start up (initialize) the system using a single laser with a sharply focused beam. Generating less than 500,000 events per second in the sensor ensures the maximum accuracy of time stamps, by reducing their jitter or random temporal error to a minimum.

In a multi beam system, it may be more advantageous during calibration to first only activate one beam and ensure that the spindle motor has achieved a steady constant spin velocity that is not excessively fast. For example, a beam generating between 250,000 and 500,000 signal events per second (in each sensor) should yield a sufficiently large event data set containing 1 to 2 million data points of sufficiently high quality. Also, this dataset can then be used both to refine the 5 degrees of freedom (DoF) estimation of the N virtual projector origins locations (3DoF: X, Y & Z) and the exact spatial directions of each of those N laser beam sweep rotations (2 DoF: 2 angular/directional dimensions).

In the exemplary 4×1 system with the octagonal kaleidoscopic laser scan system, the first step of calibration of the projection system would generate a total of 40 calibration parameters (8×5 DoF) which captures the exact geometry of the system.

The next step is an extremely accurate calibration cycle that would establish the exact RPM of the motor. With 1,120,000 timestamps per second, captured by the 4 sensors after 25 revolutions of the spindle mirror each yielding 44,800 datapoints every 40 milliseconds, the cycle time could be measured to a precision of a microsecond. So, e.g. a cycle time might be observed as 39,992 microseconds rather than the nominal 40 milliseconds.

Calibration of the 4×1 system, after 25 cycles and capturing more than a million data points, makes it possible for each virtual projector to establish its exact scan progression as a function of time. The objective is to establish for each projector the instantaneous rotational positions of the laser beams as they sweep from the system.

The exact angular position of the spindle mirror is established similarly with very high precision, i.e. to 1/40,000^{th} fraction of 360 degrees or with an angular exactness of 1/100^{th} of a degree. Thus, for each stroke the system is able to establish where exactly the beam was in its 45-degree progression across the FoV of the camera to 1/4500^{th} of its 700 row/column trajectory.

From the above observations it follows that e.g., by holding the spindle motor speed as constant as possible, the system here described should be able to establish by interpolation the exact periodic cycle of projector's eight strokes. The 3D motion of sweeping laser beams can be precisely determined. Also, the exact 3D positions of eight virtual origins can be established with great accuracy. This accuracy significantly exceeds that of a prior 4×4 system design, which relies on a projector agnostic algorithm.

What is envisioned is a system that constantly evaluates the scan patterns of its main laser beam for the last second, gathering upwards of a million readings, and which then is used to extrapolate scan trajectory parameters from this data and adjust certain system motion variables so accurately that it can compute 3D metrology with more than 4 times the precision of a “projection agnostic system.”

During calibration the exact motion of N (2−8) virtual projectors and the exact geometry of their periodic sweep patterns can be characterized for each of these virtual projectors. Exactly how these laser beams move in 3d space can be fully characterized as a periodic function of time, i.e. result in a precisely observable and entirely predictable motion geometry that is purely a function of time.

Additionally, depth estimation errors caused by time stamp errors (lags) can be mitigated. Opposite and simultaneous stereo pairing can enable a fine tuning during the calibration that substantially nulls out the triangulation depth error when a laser trajectory is observed by a pair of stereo cameras whose baseline happens to coincide with that stroke direction. Further, when the laser spot is moved by a beam whose rotation in space is substantially along the same axis as the epipolar direction of a pair of cameras then any time stamp jitter in either of the cameras would lead to an incorrect pairing up of the successive positions along the trajectories.

Note that as each successive stroke turns towards another compass direction (Southeast, South, Southwest, West, Northwest, North, Northeast & East) there is at least one pair of cameras whose baseline orientation is substantially along that particular stroke direction and at least one pair of cameras whose baseline offset is substantially transverse (orthogonal) to that particular laser stroke direction. This dual fortuitous coincidence is a direct consequence of the symmetry of the 4×1 octagonal geometry arrangement.

During calibration, when using a planar target, e.g. moving this target back and forth along the Z axis, there are sometimes two pairs of cameras of each kind. As shown in FIG. 2, when the laser beam reflects off the North facet of the Kaleidoscopic mirror, the resulting 45-degree rotation of the beam in the Eastward direction pivots around virtual origin O₈′. When such a stroke scans a laser spot across a planar target at sufficient distance, in the overlapping view of all four cameras, two camera pairs will see this eastward stroke along their epipolar axis (C₁C₂ and C₄C₃) and two camera pairs will observe the same Eastward stroke as transverse to their epipolar axis (C₁C₄ and C₂C₃). Further, triangulations from these four different stereo pairings can yield 3D estimations that can vary significantly in estimation accuracy when a significant timestamp lag (error) is present in the event camera signal.

For the aforementioned Eastward stroke, when the z distance is estimated by triangulating two corresponding temporal point pairs along two matching event trail trajectories recorded by the C₁C₂ pair of cameras, it can result in a less accurate z distance estimation. This distance is estimated by triangulating two corresponding temporal point pairs along two matching event trail trajectories recorded by the C₁C₄ pair of cameras, because the latter pair's baseline separation is substantially transverse to the motion of the flying spot, and the a systematic lag in the timestamps does not affect the differential of row numbers by which the C₁C₄ pair records the Eastward trajectory (the disparity between the cameras being substantially orthogonal to the stroke).

In contrast, results from observations of the C₁C₂ pair of cameras might be much less accurate because any lag variation (due to time stamp jitter) between the two cameras would result in an incorrect matching of stereo correspondences between those cameras for strokes in the Eastward direction. The latter observation is by analogy equally true for strokes in the opposite Westward direction.

Further, a way to improve the Z distance estimation for any point P on a remote manifold is to compare the results of triangulation of the 6 different stereo pairs (C_{I}C₂, C₂C₃, C₃C₄, C₄C₁, C₁C₃ & C₂C₄), and up to eight different stroke directions, for a possible 48 different ways to estimate the position of the same point P on a surface.

Some combinations of scan direction and camera pair selection can yield results with greater accuracy, as indicated by a smaller repeat sampling error and by comparing the results of various combinations to a known ground truth data, such as a Computer Aided Design (CAD) model e.g. of the scan's 3D calibration target.

The precise knowledge of the beam scan geometry and motion can be used. For example, as discussed herein, careful calibration of the origin location of each virtual projector can be estimated with high precision. Also, the two polar angular dimensions of any stroke in any direction can be known ex ante by the system as they can be both observed and predicted from the geometry of the Kaleidoscopic mirror. The latter is true when the rotation of the beam is held constant in two dimensions, which would be the case when the spindle mirror spins without any change in the angle of the mirror itself (i.e. no fluttering, varying this angle). If the angle is changed this change can be observed with a direct feedback loop from the mirror, or it can be estimated by observing the sequence of strokes shifting on a surface.

Additionally, bootstrapping a 4×1 system using camera only based triangulation methods may be employed. By using current “projector agnostic” algorithms, an initial estimate of the target 3D surface geometry may be calculated. Then, by choosing a known, precisely controlled constant spindle mirror rotational velocity (omega), a very accurate estimate of the extrinsics of the virtual projectors may be known. Then in the next step, by multiple iterations of methods just described, a scan of the reference surface may be refined by further improving the estimation of both the camera and the projector extrinsics. This iterative bootstrapping can be automated until the incremental improvement (sampling error on a planar surface e.g.) falls below a minimal figure of merit improvement threshold.

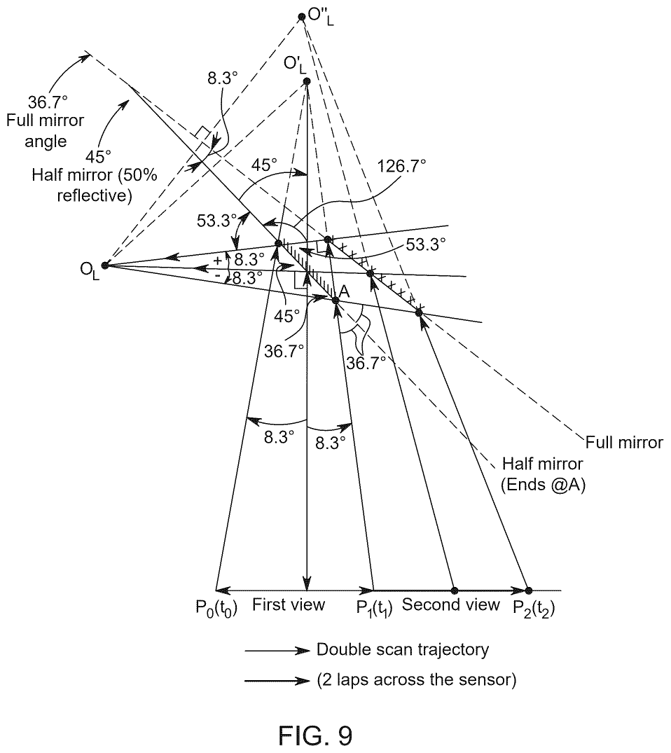

As shown in FIG. 8, a beam splitting dual layer concentric Kaleidoscopic mirror may be employed. This is a way to provide good scan coverage across the Field of View (FoV) of the system to construct two concentric rings of facets around the spindle mirror. The inner first ring is comprised of partially transparent mirror surfaces. For example, the spinning laser beam may be 50% reflected and 50% transmitted by the inner kaleidoscopic facets. Further, an outer ring may be used to redirect the transmitted second portion towards the FoV also.

The two kaleidoscopic mirror rings of facets may be of equal number, e.g. both might be shaped as a regular octagon. Or alternatively, the inner ring might have fewer facets. For example, in FIG. 8, a hexagonal ring of facets is shown fitting within a larger outer ring of 8 facets of a regular octagon. One advantage of this configuration is that by reducing the number of facets comprising the inner ring, the strokes produced by that inner ring will be longer and thus more equal to the length of the strokes produced by the outer ring. For example, the hexagonal inner kaleidoscopic mirror facets shown drawn in FIG. 8 expand up to 3 inches in length, which equals the length of the facets of the outer hexagonal kaleidoscopic mirror. 6×3 inches makes an 18 inch circumference which fits well withing an octagon of 8 times 3 inches with a 24 inch circumference, i.e. fewer but longer strokes in the middle.

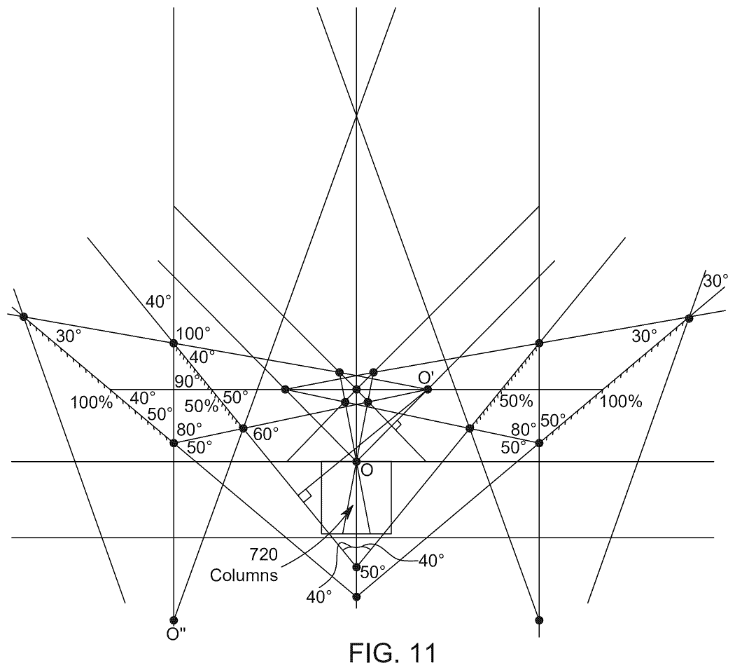

“View Folding” provides for doubling the field of view of the cameras by use of half mirrors. As shown in FIG. 10, for one of the cameras in the scanning system of the KGVP, a first half mirror facet redirects ½ of the FoV of the surface being scanned below, and a second mirror facet redirects the second ½ of the FoV of the surface being scanned below the system.

In this example the narrow FoV of an event camera is essentially being doubled by this arrangement, so that 720 rows are doubled to 1440 rows of 1260 pixels. One advantage is that the double view folding makes the scanning system more compact. Another advantage is that 1440×1260 view makes for less rectangular view than 720×1260 of an event camera.

As a laser beam spot scans from point P₀ at to t₀ the right towards point P₁ at t₁, the first half mirror will redirect 50% of the light towards the event camera aperture at O₁ the image of the spot traverses the full span of 720 rows in the event sensor, then at t₁ the light of the spot will be captured by the second full mirror and again traverse the full span of the 720 rows of the event camera. In other words, one stroke of the laser will result in a double stroke in the camera. The system software can differentiate (in time) the first stroke from the second stroke and map it to the correct positions on the surface being scanned in the field of view. This field doubling is a powerful method to gain resolution in the scanning system without adding more event pixels or cameras to it.

When using event cameras to track a scanning laser spot, events are detected “as they are happening “in real time, rather than in large simultaneous captures (” frames”) is what makes this possible.

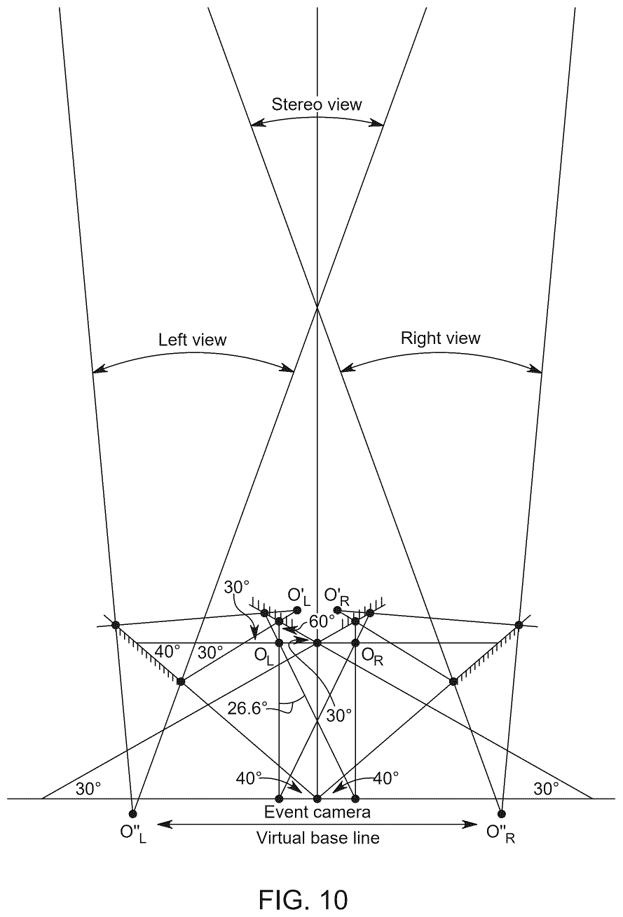

Yet, even when using regular “frame” cameras, when tracking the trajectory of a spot scan by a laser beam on a surface, it is possible, e.g., by a slight angular off set to make the image trails of the spot in the sensor, two consecutive laps such as shown in the “first view” and “second view” in FIG. 9) land at slightly different columns so that the triangulation system can disambiguate the first trail from second. (the two trails—or trajectories would be very close in the sensor, but not wholly overlapping). This configuration would be a suitable for inspecting smoothness of surfaces.

A single sensor ultra compact stereo scanning system is shown in FIGS. 10, 11 and 12. A compact light weight metrology or tool guidance vision system can be constructed using a single even camera, by folding the left view and the right view of a stereo (2 view) system onto the same sensor via a series of relay mirrors.

FIG. 10 shows how one sensor, such as an event camera can capture light through dual apertures with a left aperture at O_{L} and a right aperture at O_{R} that light from a pair of two-stage relays to illuminate (project onto) a sensor. A scanning laser beam (not shown) project a spot on remote surface (not shown). Due to the dual apertures and the mirror relays two images of the same spot will occur on the same sensor. There are 2 virtual camera centers O_{L}″ and O_{R}″, with a significant virtual baseline separation between them (approx. 5″ in this drawing).

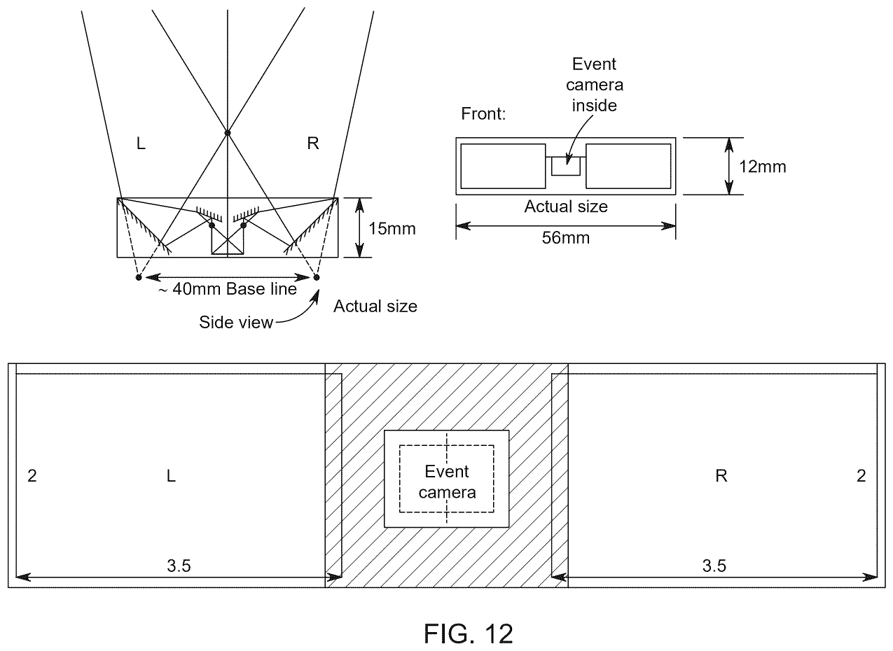

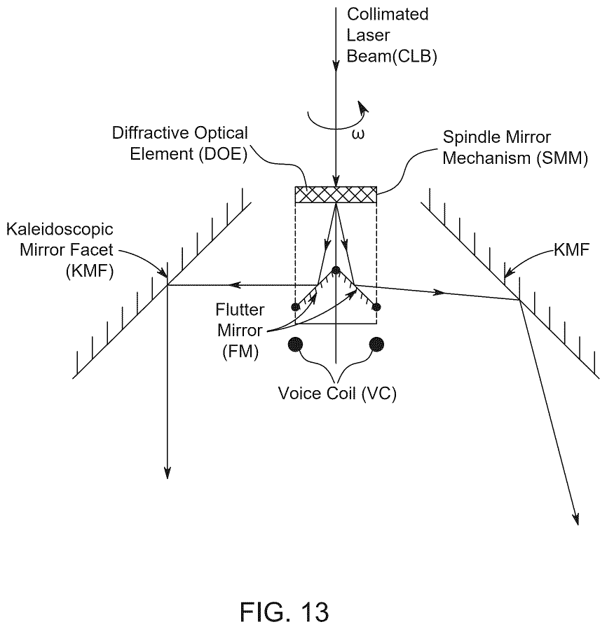

FIG. 11 shows a stereoscopic (2-view) system with a single sensor with dual folded optics doubling the resolution, both the resolution doubled left view and resolution doubled right view being relayed by a prism like construction with crossed half mirrors that allow a portion of four of the views (two left and two right) reach the event camera and project both a left view and a right view image on to the same event camera. A laser spot on a far field surface (not shown) as it traverses the full width of the scanning system FoV would cross the 720 columns of the event camera in two consecutive laps. Additionally, FIG. 12 shows a possible ultra compact scanning stereo scanning system using an event camera, which could be—if desired within a 56 mm (W) by 12 mm (H) by 15 mm (D) enclosure

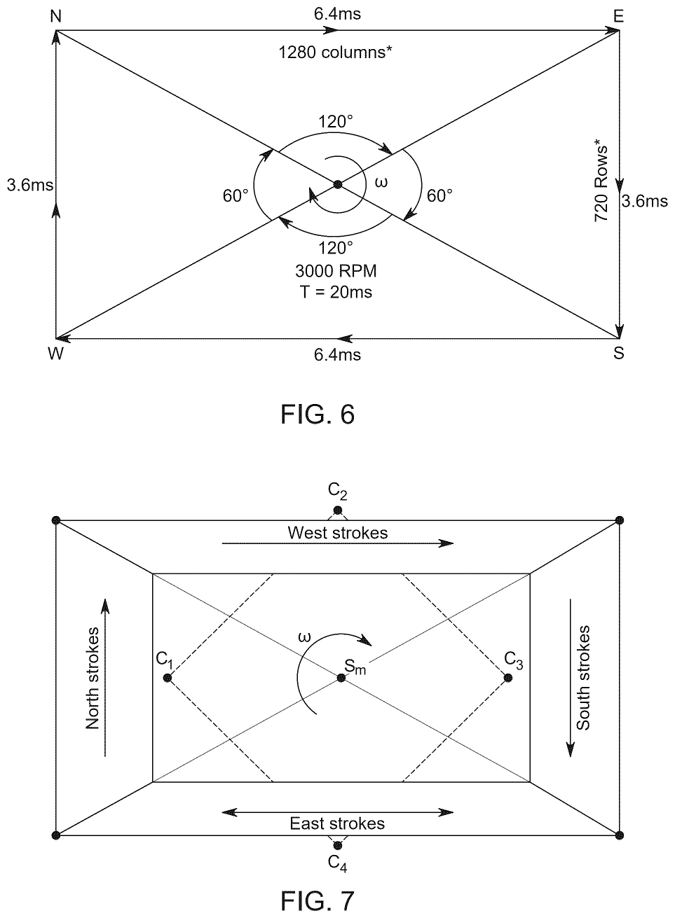

FIG. 6 shows an exemplary 4×1 system with a rectangular four stroke projection system for the KGVP. It is possible to arrange the facets of the kaleidoscopic mirror in irregular shapes or at angles to match the scan requirements of Kaleidoscopic scanning system. There is almost unlimited design space and allows for a great deal of modularity. The mirror shapes and angles can be changed without significant changes to the software or electronics of the KGVP. The geometry can be calibrated by itself as shown herein.

FIG. 6 shows an example of how shapes and scan angles can be tailored to fit. For example, an event camera having 720 rows of 1280 pixels of 4.86 by 4.86 micron each, the natural shape of the scanning is a landscape mode FoV with a 1.78× aspect ratio (Width =1.78× Height)

To scan in four directions with a four sided kaleidoscopic mirror arrangement across this rectangular FoV, the vertical strokes (North and South) can be shorter than the horizontal strokes (East and West). As the spindle mirror (SM) spins the laser beam, the short vertical strokes each require approx. 60 degrees rotation each, and the long strokes require approx. 120 degrees of rotation. For 2×60+2×120=360, the horizontal stroke and vertical strokes are of equal angular velocity ω. Also, the RPM of the spindle mirror can be set to achieve an optimal pixel transit time, e.g. approx. 5 microseconds. For this embodiment, the horizontal strokes should take 1280×5=6400 microseconds, or 6.4 milliseconds. Further, the vertical strokes should take 720×5=3600 microseconds, or 3.6 milliseconds. Thus, the total cycle time will be 20 milliseconds (50 Hz) and the motor should run at 3000 RPM

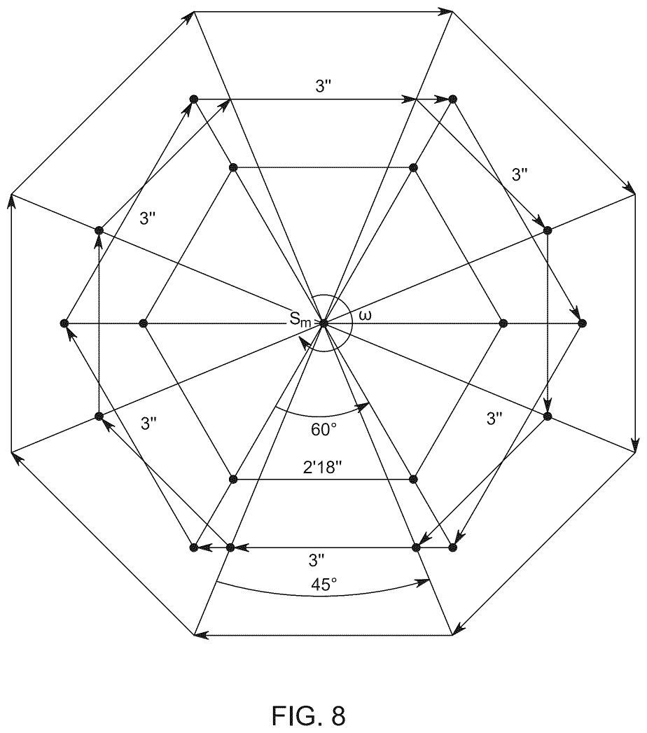

FIG. 7 shows that in such a rectangular system it may very well be optimal to place two of the cameras just inside the kaleidoscopic mirror ring, C₁ C₃ are placed inside short vertical facet mirrors, whereas C₂ and C₄ just outside. In this configuration the baseline distance and toe in angles of the four camera pairs remain approximately equal. This arrangement reduces the width of the system, keeping it more compact and creating a more effective volumetric overlap between the four cameras.

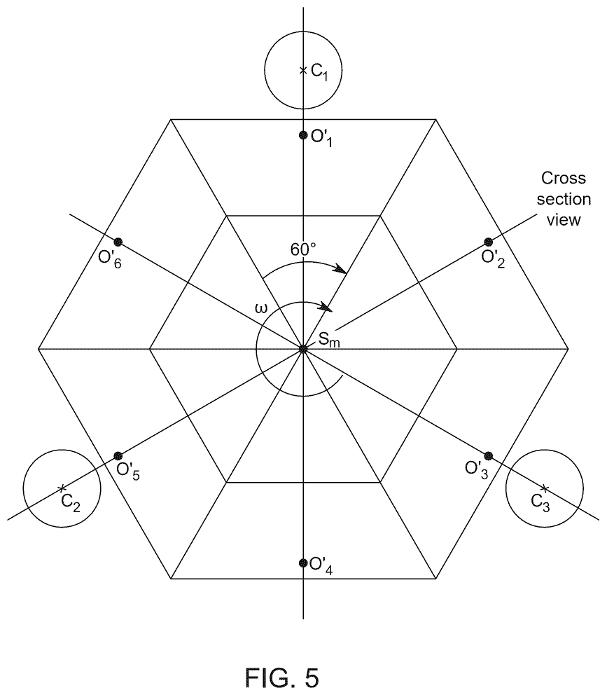

FIG. 5 shows a Hexagonal “3×1” system configuration with 3 cameras C₁, C₂, and C₃. As the spindle mirror rotates it creates six 60-degree strokes. Note that by precise calibration of the laser scan sequence, determining the virtual origins (O₁′ . . . O₆′) of the six virtual projectors, three of these lie directly opposite to one of the three cameras, and the other three are in close vicinity of one of the cameras. Since in a well calibrated system distances can be accurately estimated with a single Camera this three camera arrangement is already a very powerful multiview 3D vision system, with many possible combinations of view angles and illumination angles.

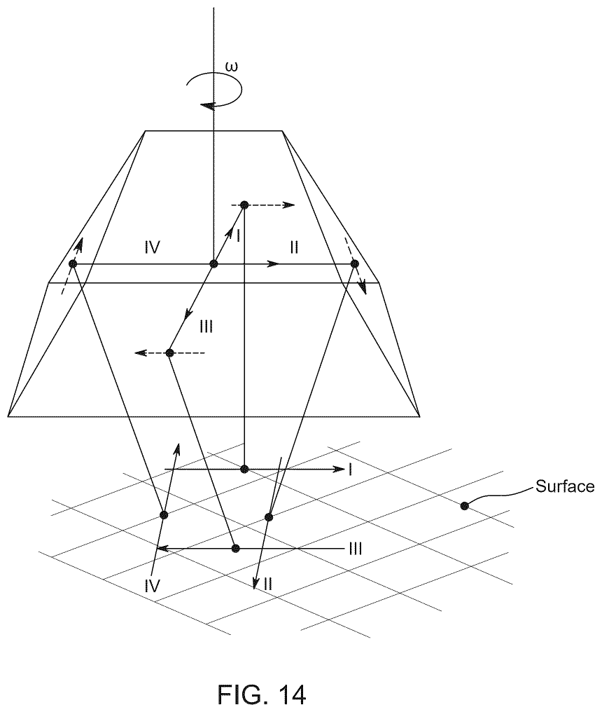

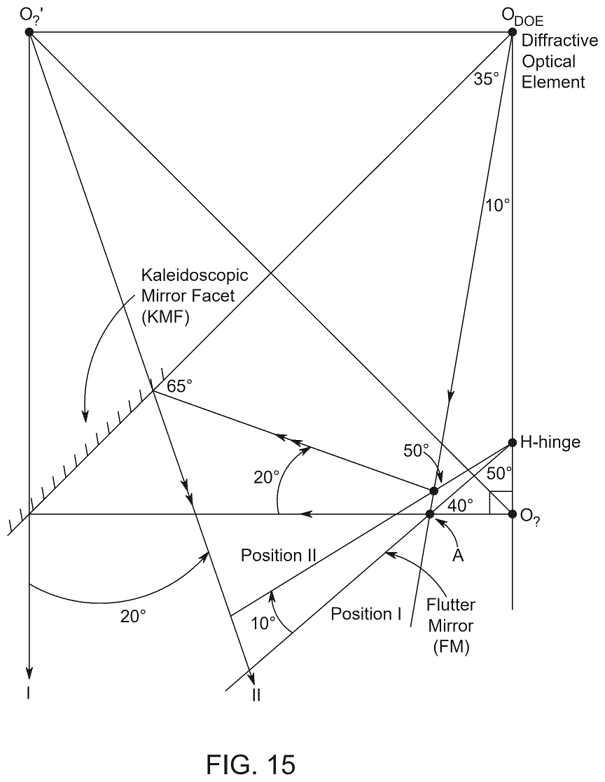

In FIG. 13, various elements and observations may be shown as follows:
1. A plurality (M) of collimated Laser Beams (CLBs) is swept around by a spindle mirror mechanism (SMM). Typically, M is 4 or greater.
2. This plurality of beams may be created by an optical beam splitter, such as e.g. diffractive optical element DOE, affixed to the SMM.
3. The reflected laser beams radiate out from the SMM in a plurality of radial directions from its center of spin.
4. Each of the radiated beams emanating from the SMM swirling out from the SMM in a circular motion makes a full 360-degree rotation.
5. The SMM assembly has M mirror surfaces, where each mirror reflects one of the M beams.
6. Each of the M mirror surfaces of the SMM may by design have a deflection angle that is slightly different from the other mirror surfaces, so that during a full rotation the N beams or N sets of beams will follow non-overlapping spatial trajectories. If desired these N unique scan trajectories can be spread out significantly, so that during a single revolution of the SMM they span a substantial portion, if not all of the FoV of the system.
7. Optionally, each of the M mirror surfaces of the SMM is mounted with a hinge and flexure so that its mirror can “flutter,” changing its effective deflection angle slightly during successive rotations of the SMM.
8. Thus, the SMM has M “flutter mirrors” (FMs) combined in a single rotating assembly.
9. These Flutter motions might be caused by centrifugal forces, which can be varied by varying the rotational velocity (ω) of the SMM.
10. These flutter motions might be further amplified by the specific resonant response characteristics designed into each of the flutter mirrors in the SMM.
11. These Flutter motions may be further controlled by a toroidal magnetic field created by a Voice Coil (VC) assembly mounted in the vicinity of the spinning SMM.
12. N Kaleidoscopic mirror facets (KMFs) are arranged in a concave configuration around the spindle mirror mechanism. Typically, N is 4 or greater; N may be equal to or greater than M. These facet mirrors reflect, redirect and subdivide the rotating trajectories of the M beams into M×N new, distinct, fractional sub-trajectories.
13. Typically, at any one position of the SMM each of M beams will be deflected by a different KMF.
14. Thus, at any one time, there will be M laser trajectories in progress coming from (at least) M different locations and sweeping in M distinct scan directions in the FoV of the system, at the same time.
15. The KMF redirection angles maybe arranged so that some or all of these simultaneous scan trajectories will cross on the surfaces of objects in the field of view of the system. (See FIG. 14)
16. Therefore, any of these M×N trajectories in progress simultaneously can be unambiguously and uniquely identified by each of the cameras in the system, eliminating the pairing association ambiguity of systems disclosed in previous disclosures.
17. The motion of a laser spot on a surface of an object is entirely due to the rotation of the beam effected by the rotation of the spindle mirror. Its sweep location and sweep direction are affected by the position and orientation of the mirror facet, but its rotational (angular) velocity (ω) is not.
18. Thus, each of the sweeping laser beam patterns observed is substantially identical in speed (angular sweep progression, or ω) and only differs in sweep direction (two DoF) and the spatial position of the virtual origin (three DoF).

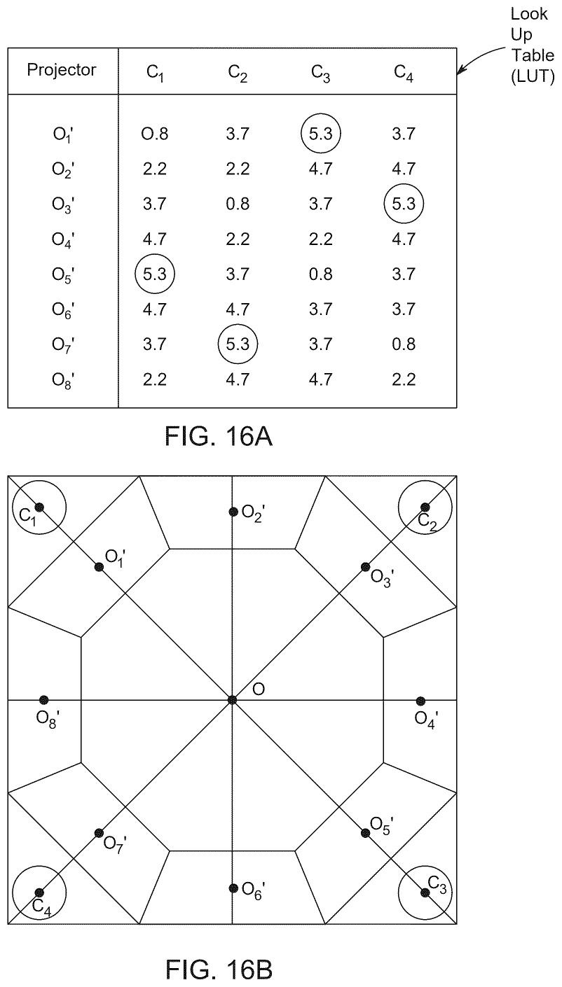

For “Hinged Petals” a plurality of flutter mirrors are arranged to twirl below a two dimensional (2D) DOE. As shown in FIG. 15, a DOE at position O splits a collimated laser beam into a 2D pattern of N sub beams. FIG. 15 further shows only one of the beams being deflected by the DOE at a deflecting angle theta, e.g. at the first order maximum. The deflection angle drawn is 10 degrees. This beam is deflected again by a Flutter Mirror (FM) towards the mirrored facets (MFs) of the Kaleidoscopic mirror. The Flutter Mirrors (FMs) are arranged like oblong shaped “petals” (as in flower petals) that are mounted on hinges at the spindle axis at point H. This hinge allows a flutter mirror to flutter (change angle) to a certain degree. For example, in Position I, the flutter mirror is angled at an angle of 50 degrees from the central spindle axis and the laser beam impinges at position A, at an angle of 40 degrees (50 degrees minus 10 degrees), adding a further 80 degree deflection at point A. Added to the 10 degree deflection caused by the DOE this makes for a total 90 degree deflection. Thus, as drawn, with the flutter mirror (FM) in position I, the beam reflected off the petal at point A is now horizontally radiating out towards one of the Kaleidoscopic mirror facets (KMFs).

Further, by moving the Hinged Petal Flutter mirror by 10 degrees, from position I to position II, it causes a 20-degree rotation of the reflected beam directions, first upwards towards a reflection point that lies at a higher elevation on the Facet Mirror. After reflecting on the latter (fixed) mirror surface the beam heading towards the FOV of the scanned laser imaging system has rotated the same 20 degrees towards the right, i.e. towards the center of the FOV of the system.

It is significant that by hinging the flutter mirror petal at position H, rather than in its middle or closer to position A, it is possible to effect this rotation without the flutter motion causing a translation of the virtual origin (O_{?}′). The latter is a mirrored reflection of the rotation point O_{?} which like point O at the DOE and the hinge position H, are all colinear with the axis of rotation of the system. (H, O and O_{?}; all three points lie on the spindle axis.)

Thus, a Kaleidoscopic system can have multiple flutter mirrors, each reflecting one or more sub beams created by a 2D DOE, and that it is possible, by carefully selecting the hinge position of each petal, to create an ensemble of simultaneous scanning and crisscrossing trajectories. And the resulting virtual projectors can have virtual origins in 3D space that are in effect stationary, despite the dynamics of multiple successive reflective redirections and the motion forces of the spindle axis and their effect on the individual flutter motions of the individual mirrors.

Low latency multiview 3D vision systems that are computationally efficient provide several advantages to multiview 3D machine vision, such as the following:
a. The ability to see objects from multiple angles is critical for robots to correctly identify them as discrete objects, to recognize them by their shapes, and to correctly track the position and motions of the objects in space.
b. A multiple perspective view of an object is often critical for a robot to be able to deftly grab and manipulate an object (e.g. it is important to see at least two opposing sides of an object for most end effectors to successfully grasp it)
c. The ability to see 3D structures fully with minimal occlusions, shadows and blind spots.
d. The ability to look into hard-to-reach places, such as deep trenches or bolt holes or threaded cavities, places where fasteners are supposed to go, or to inspect welding spots and seams, metal folds and glue beads.
e. The ability to check dimensions in hard-to-reach places, and to spot, and if necessary to remove milling debris or metal burs, or any small particulates that tend to nestle in and contaminate these places.
f. The ability to fill blind spots that otherwise might be exploited in automated security systems, such as perimeter defenses and intrusion alarms.
g. To ensure as much as 100% operator safety, there cannot be any visual blind spots around a working industrial “cobot” (a robot working with and among humans in a factory)

Implementation of 3D multiview systems have many challenges such as the following:
a. Computational complexity. N view systems, to work correctly, require ˜X^{N} computations: A pair of cameras (N=2) looking at the same scene with potentially 10,000 features (X=10,000) from 2 distinct angles of perspective might have to pair 10,000 pairs correctly, which translates to finding the correct 10,000 out of 100,000,000 possible combinations: (10,000)². For a 4-view system that would be (10,000)⁴, 10¹⁶, 10,000,000,000,000,000,000.
b. Known short cuts to the above computational problem require massive calibration and impose stringent rigidity constraints on camera pose extrinsics. Because of this, the resulting systems are brittle, hard to deploy and typically intolerant to even modest vibration to be found in any manufacturing location. Thus, real-time multiview systems with more than 2 simultaneous camera perspectives are simply impractical.
c. The N view feature matching problem creates inherent computational bottle necks, which tend to defy attempts to address the computational load by parallel processing in GPUs and such.
d. As a result, N View systems suffer from speed-and through put limits and have inherent high latency.
e. In 3D systems that project active patterns with multiple projectors and 4 or more cameras looking simultaneously have been put in operation. However, aside from the compute complexity created by the plurality of camera perspectives, the required plurality of projectors requires strict sequencing of the strobes, which adds both latency and more motion uncertainty due to the inherent observation gaps between cycles.

Thus, having a way to realize the advantages of such N view systems and mitigate or remove the disadvantages of such systems would be a valuable addition to the 3D sensing and machine vision technology solutions landscape.

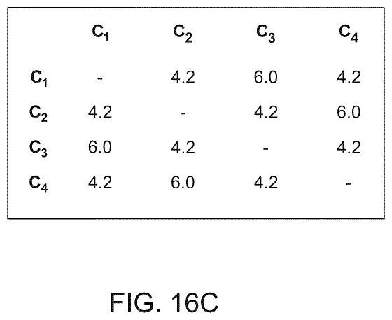

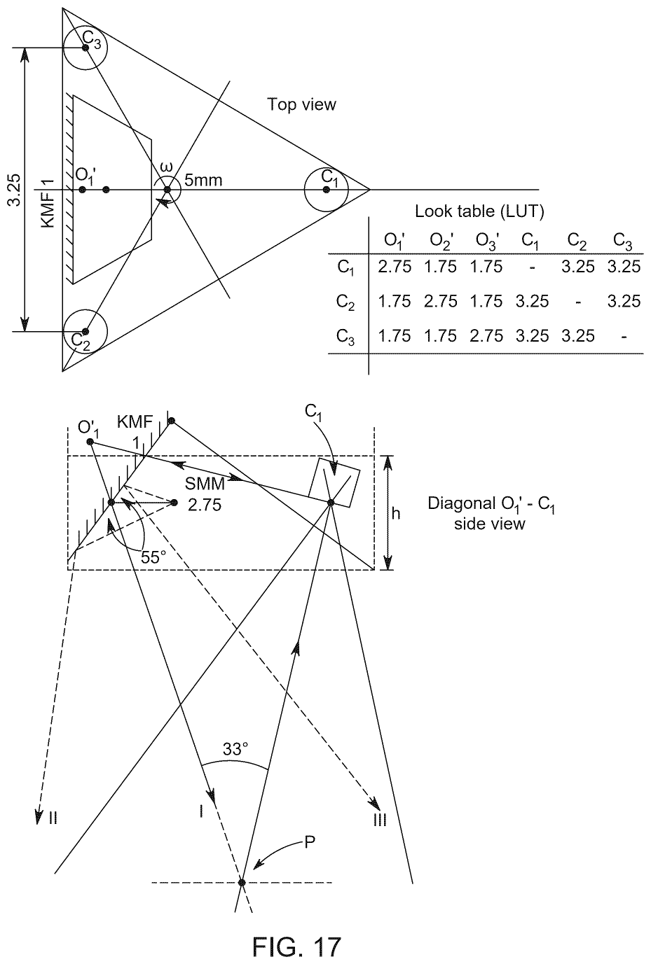

The various embodiments of the KGVP enables a 3D machine vision system with M virtual projectors and N simultaneous views with several advantages such as follows:
1) N and M are typically 4 or larger (and may be very large).
2) During calibration, a “look up table” (LUT) (See FIG. 16A) is created based on the observed extrinsics of the projection patterns, both the five DoF motion of laser beams in space as a periodic function of time, and the exact intrinsics and extrinsics of the sensors.
3) This LUT has, at a minimum, M×N entries: For each of the M laser beam projectors there are N entries, one for each of the M sensors in the system.
4) Each entry is a pre-computed ranking (grading) of the potential contribution value of this pairing in a Tx-Rx triangulation, the triangulation of the spatial surface point based strictly on these two values.
5) The first value is the instantaneous five DoF position of the laser beam in space (its virtual origination point (x, y, z) and its direction (α, ε) based on a microsecond precise time interpolation. The latter might be realized by a look up function which is itself based on the periodic motion observed in a most recent time interval).
6) The second value is based on a 2D spline position estimation in the sensor pixel space, also observed as a function of time (microseconds in the event camera).
7) Both values may be functions of time, and thus the parameter in the look up table might also be a function of time.
8) Each parameter in the look up table is relative to the others—i.e. creating a rank order.
9) (optional) Multiview combinations, i.e. cases where a section of laser trajectory is viewed by multiple cameras simultaneously, can be added in addition. These entries would also be ranked relative to the other entries, establishing the expected geometric triangulation quality factor relative to the single view Tx-Rx pair estimation. (see FIG. 16B)
10) During the initial calibration, e.g. by moving a planar calibration target through the 3D space in front of the system, an initial set of parameters is created for this look up table.
11) During operation the expected (periodic motion) 5D trajectories of the sweeping beams enable each camera to anticipate and correctly identify which of the M (virtual) projectors is creating the trajectories in its view. Disambiguation, as noted elsewhere, is based on both each laser beam's the motion pattern and the exact time in the cycle. The time determines the phase in any beam's periodic cycle of motion in five DoF space, where each pattern for each projector in each phase in the cycle is either fully unique or easily distinguished from others in view.
12) Thus, each individual sensor's local computational subsystem (each of N) can correctly label (identify or match up) any sections such as it happens to perceive from its perspective with the right projector out of M projectors
13) With the Correct Tx-Rx combination (association) an initial single sensor triangulation can be achieved without a central sensor-to-sensor pairing requirement.
14) Further, in the case where multiple cameras are observing a certain segment of a laser trajectory simultaneously, the look up table will predict which of several possible camera perspectives of that segment is most likely to produce the most accurate triangulation. So, in a system with a large number of (virtual) projectors and a large number of event cameras, the compute budget can be optimally allocated by selecting those pairings or combinations with the highest ranking in the table. (See example of a three-way Tx-Rx system FIG. 17)
15) The table does not have to be static. In a many sensors system, it is very likely that large sections of trajectories are observed by two or more cameras (some even by all).
16) Thus, the look up table (LUT) can be continuously updated, based on the most recent ensemble observations of each of the virtual projectors scan patterns.

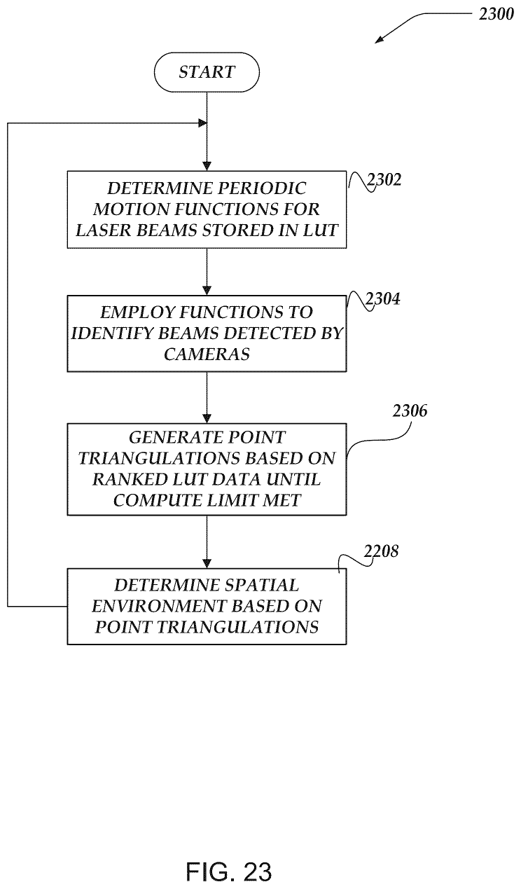

FIG. 23 illustrates a flowchart for overview 2300 of a method to accurately and efficiently triangulate points on a spatial surface. Moving from a start block, the method flows to block 2302 where during a calibration process, a periodic motion function in five DoF for each laser beam projected by each virtual projector is determined and subsequently stored/added to the LUT.

At block 2304, the periodic beam motion functions are used to identify each laser beam detected a camera. Stepping to block 2306, the most likely to produce highest to lowest predicted accuracy rankings for the Tx-Rx pairs stored in the LUT are used to sequentially triangulate points based on the ranked pairs until a predetermined computational limit is met.

Moving to block 2308, the point triangulations are used to determine a spatial surface environment for use by other processes and/or applications. Next, the method loops back to block 2302, and iteratively performs the method disclosed herein again. In this way, a highly accurate triangulation of points that may be used to define a spatial environment may be achieved without consuming computational resources that could exceed a predetermined computation limit or constraint.

Additionally, the bidirectional diversity of the virtual projectors have several advantages. For example, the benefit of widely spreading out the optical centers or origins of the virtual projectors. One of the major potential benefits is that with minimal parts and a fairly simple beam scanning mechanism—the flutter mirror mounted on a single tiny, cheap and low power spindle motor, “N projectors are provided for the price of one” by using N mirror facets in the Kaleidoscopic mirror.

Another advantage of having a plurality (N>3) of these “virtual projectors” (mirrored reflections of the same central projection system) I is that they can be arranged such that each of the N virtual projectors can send scanning laser beams into the working volume of a robotic 3D Vision system from a unique and different perspective.

To the extent that a 3D structure is complex, with protrusions, holes, ridges, slots, folds and such, it presents a significant challenge in observing such a structure with a mono-scopic camera system or in case of a 3D scanned system with a conventional system comprised of a single laser scanner (Tx) and a single camera (Rx). The main reason is that for accuracy it is desirable that the angular convergence between the laser impinging on the surface and camera's perspective of that the surface being scanned should be between 10 and 40 degrees, with a greater “toe-in” angle (vergence) resulting in significantly greater precision of the depth estimation.

However, the extra precision might result in a reduction of 3D surface that can be scanned. The greater toe-in between the impinging laser and the chief ray reflected to the optical center of the camera, the more areas in a complex 3D structure will be beyond the reach of such a system.

Therefore, when scanning complex 3D structures having a plurality of lasers impinging and angular diversity combined with a plurality of cameras that can receive the reflected light with a similar angular diversity (from a diversity of perspectives) can result in a more complete scan coverage of such complex 3D structures.

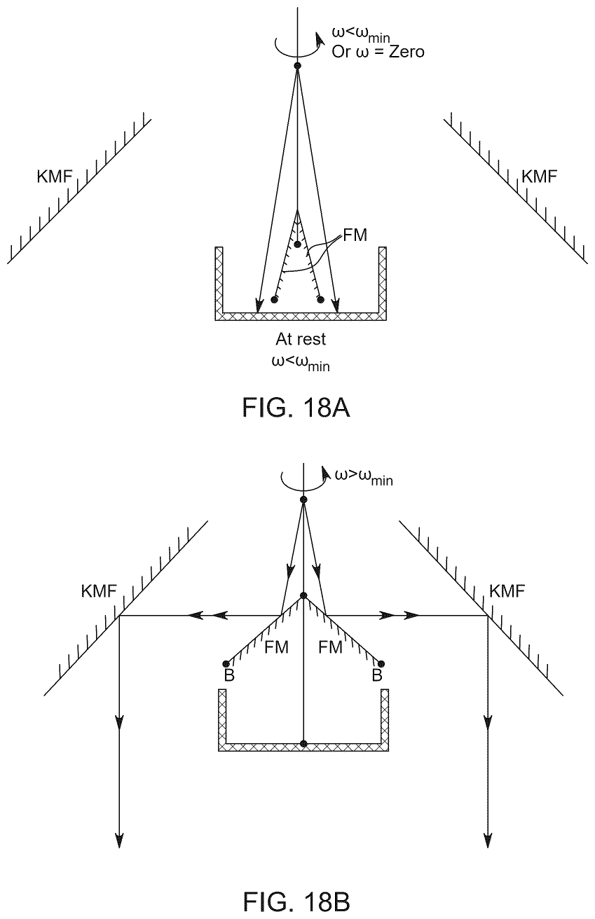

The various embodiments of the KGVP enables a hinged dual flutter mirror using a DOE, which provides a bonus scanner eye safety feature. As shown in FIGS. 18A and 18B the advantages are as follows:
1. Two mirrors hang off the same bar (hinge posts).
2. The mirror surfaces are coplanar with the axis of rotation of the hinge.
3. At rest, the two mirrors either are folded up by a spring force or down at some minimal angle (εₘᵢₙ) with (subtended from) the spindle axis of rotation.
4. At this εₘᵢₙ, the laser beams do not impinge on the mirror surfaces and thus no laser light emerges from the flutter mirror assembly (aka “the turret”).
5. Alternatively, if light does emerge from the turret (an open turret design) then at this minimal deflection angle these beams would miss the kaleidoscopic facets, which can be designed with a light absorbing baffle that would prevent this light from emerging from the projector.
6. The hinges are spring loaded to stay in the minimal (or maximal) safe angle (εₘᵢₙ) until a certain minimal rotational speed (ωₘᵢₙ) has been achieved by the spindle axis, and the hinge mirrors are rotated by centrifugal force action into their operating angle (εₒₚ).
7. Furthermore, when the rotational speed of the spindle mirror exceeds a certain maximum operational limit (ωₘₐₓ) the mirrors are extended out beyond a maximum angle (εₘₐₓ) and at this angle or greater, the light can no longer exit the turret, or misses its kaleidoscopic facet (it ends up on impinging and getting absorbed in a ‘light baffle” structure).
8. Laser beams will only be able to exit the projector's enclosure when the projector has reached an operating speed that exceeds the minimum (ωₘᵢₙ) and is below the maximum (ωₘₐₓ). The former helps ensure that a sufficient margin of eye safety is maintained when the robot vision system is operating. The latter will prevent the system from emitting laser beams at angles beyond the intended perimeter of the system.

The various embodiments of the KGVP enable triangular systems (“3×1”) such as shown in FIG. 17. Ensuring a maximal Rx-Tx disparity and having three distinct and separate camera-projector (Rx-Tx) pairs operate and scan a field of view simultaneously using a single projector. In the top view only one KMF is shown KSM₁ in opposing position from C₁.

A diagonal cross section side view shows that this system in the near field can achieve a strong Rx-Tx triangulation convergence of greater that 30 degrees (relative LUT value of 2.72), in scanning simultaneous three directions 120 degrees apart, and a camera stereo pair convergence of greater than 40 degrees. (a relative LUT value of 3.35)

It should further be noted that a camera only (“projector agnostic”) triangulation approach can possibly provide three 3D perspectives on any surface point being scanned. The alternative method of pairing the cameras with their opposing projectors, i.e. a projector informed (“non agnostic”) triangulation algorithm provides three addition perspectives. Moreover, the latter can be 60 degrees offset from the former.

Having these six perspectives can be advantageous in capturing 3D features such as in gap and flushness metrology or tool guidance system. Further, in such cases where features cannot be triangulated by a camera pair can still be seen with similar fidelity by at least one of the Tx-Rx pairs. Thus, having both algorithmic options available adds to the versatility of such a hybrid approach.

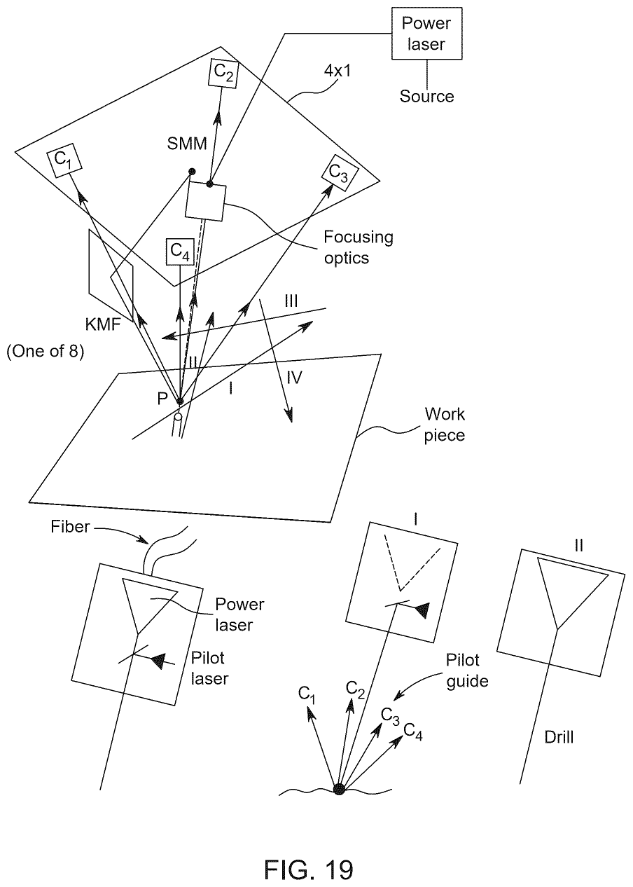

The various embodiments of the KGVP enables laser tool guidance with a system dynamically positioning e.g. a laser drill or ablation tool precisely in reference to 3D features on the work piece. See FIG. 19. A method for such laser tool guidance follows:
1. A kaleidoscopic 4×1 tool guidance system scans a work piece.
2. A detailed 3D scan geometry of the work piece is streamed into the computer system at low latency.
3. Using a Computer Aided Design (CAD) reference model for the work piece, the right locations and orientation of the drill holes or cuts are identified.
4. The power laser focusing optics focuses laser energy provided via a flexible fiber.
5. Optionally these optics are rotated in two DoF to orient the power laser drilling beam, bringing it in the correct location and orientation before firing the laser.
6. Optionally, a pilot laser, e.g. in 405 nm wavelength visible to tool guidance sensors (event cameras C₁, C₂, C₃ and C₄ in FIG. 19) confirming the laser drill optics is in the right position to fire (drill). (Step I)
7. Drilling begins and might only take a few milliseconds. (Step II)
8. After a certain amount is ablated the “pilot laser” is again lit and the 3D metrology system checks that the desired depth and profile has been accomplished.

In the case of cutting or making grooves or welding seams there can be a pre-check and a post-check on the achieved geometry, to ensure it follows the CAD model and/or to note any deviation thereof.

Similarly, when dispensing adhesive beads or glue dollops directly from the robot end effector, the glue tool guidance can assure that the correct amount of glue has been deposited exactly at the right places on the work piece.

These operations can be executed at very high speeds as there is no need to bring the scan head sensors into a stationary position for a motion blur free image exposure as there is in conventional systems. The robot tool can be in continuous high-speed motion around the work piece and the work piece itself does not need to be stationary nor fixtured to the work bench.

The various embodiments of the KGVP enable irregular shaped, positioned and angled Kaleidoscopic mirror facet arrangements. They are used to achieve greater scan coverage yet maintain a compact design and provide for successive adjacent partially overlapping strokes.

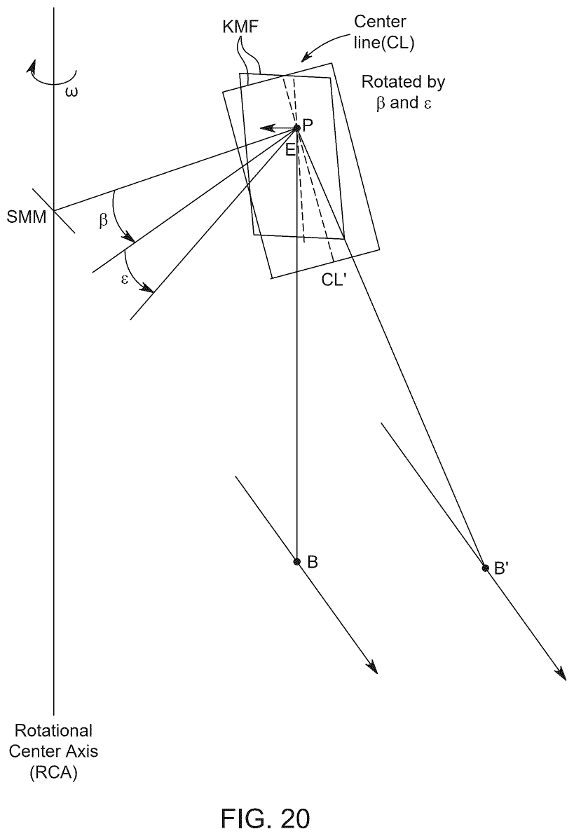

As shown in FIG. 20, a facet has been turned by a small angle (β) away from directly facing the central axis of rotation on which the spindle mirror mechanism (SMM) is spinning, driven by the spindle motor. So when one of the laser beams radiating out from the SMM reflects on a point P that lies on the center line (CL) of the kaleidoscopic mirrored facet (KMF). When seen from the top the reflection of this ray impinging at point P, it will no longer be returning to cross the rotational central axis (RCA) of the projector. Rather, it will reflect in an off centric direction, with an additional angular deviation of 2β.

Further, a vertical rotation & of the KMF moves the scan trajectory on the surface below outwards. In FIG. 20, point B and the trajectory it follows, can be thus moved radially outward and forward by adding small deviations ε and β respectively, rotating and translating B to B′.

Two adjacent facets mirrored facets of the kaleidoscopic mirror can be rotated slightly in opposite directions +β, and −β respectively, so that the reflection reflecting off the first mirrored facet directionally at least partially overlaps with the directions of reflections the same laser beam is now reflecting off the second mirrored facet.

Further, the vertical inclination of the two adjacent facets can also be varied (offset) from each other, e.g. the first facet being tilted more inward than the second, a variation off the main angle of e.g. 45 degrees by +ε, and −ε respectively.

For clarity, if the main angle were e.g. 45 degrees and & was e.g. 5 degrees, then the vertical inclination angle of the first mirrored facet would be 50 degrees (45+5) and the second 40 degrees (45−5), and the resulting laser beam sweep trajectories would be spread out vertically, a total by 4 times that, i.e. by 20 degrees.

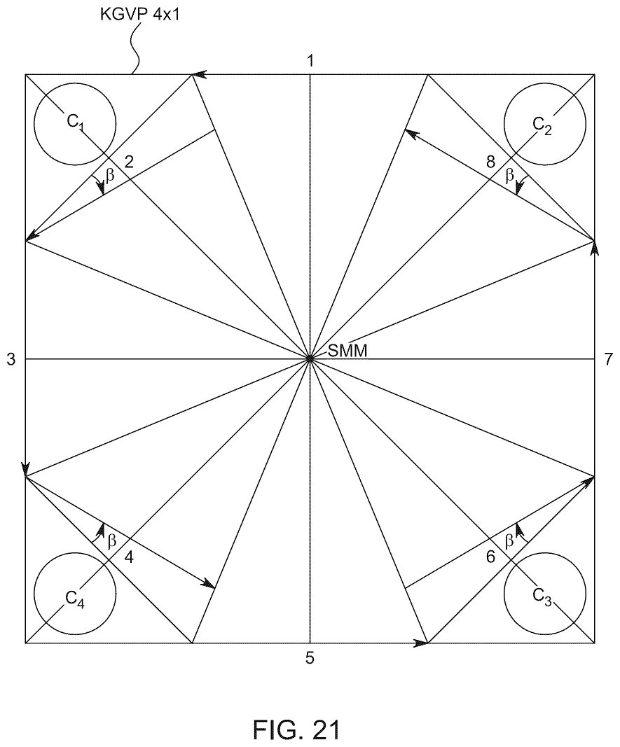

Using these adjustments to the KMFs achieve greater scan coverage yet maintains a compact design and enables successive adjacent partially overlapping scan coverages areas. FIG. 21 illustrates an exemplary 4×1 system with these adjustments.

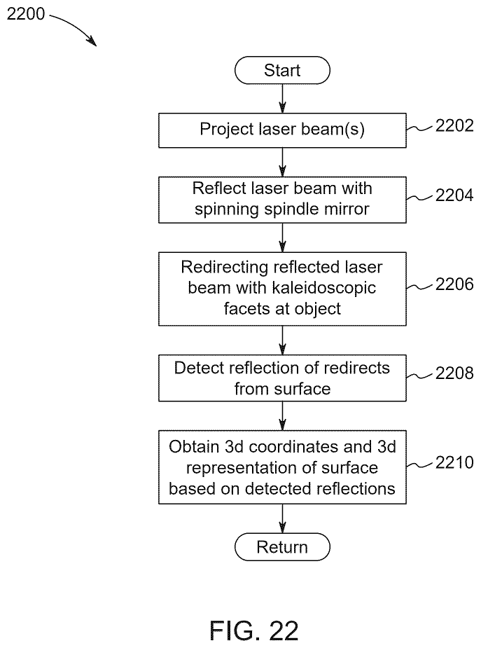

FIG. 22 discloses overview 2200 for a method for machine vision enabled by a kaleidoscopic geometric vision platform. Moving from a start block to block 2202, the process employs a projection device to emit one or more laser beams. At block 2204, the one or more laser beams are reflected by a rotating spindle mirror mechanism (SMM) that includes a rotatable reflective surface that is configured to rotate around an axis of the SMM.

Stepping to block 2206, the one or more reflected laser beams are redirected at an object surface by a kaleidoscopic mirror having a plurality of facets (KMFs) in a concave arrangement around the SMM. The arrangement of the plurality of KMFs creates multiple virtual projectors having a distinct virtual origin point and a sweep direction for each KMF.

At block 2208, one or more reflections of light are detected from the object surface that is illuminated by the one or more redirected laser beams. The detection is provided by a plurality of cameras arranged around the KMFs and may include frame cameras, event cameras or both.

Moving on to block 2210, a correspondence is identified between the one or more detected light reflections and one or more identified virtual projectors based on timing information associated with each of the one or more detected light reflections. Next, triangulation is used between an origin for each identified virtual projector origin and a position of each camera that detected light reflections to obtain three dimensional surface coordinates of the object surface. A three-dimensional representation of the object surface is obtained based on the three dimensional surface coordinates. Lastly, the process returns to performing other actions.

It will be understood that each block in each flowchart illustration, and combinations of blocks in each flowchart illustration, can be implemented by computer program instructions. These program instructions may be provided to a processor to produce a machine, such that the instructions, which execute on the processor, create means for implementing the actions specified in each flowchart block or blocks. The computer program instructions may be executed by a processor to cause a series of operational steps to be performed by the processor to produce a computer-implemented process such that the instructions, which execute on the processor, provide steps for implementing the actions specified in each flowchart block or blocks. The computer program instructions may also cause at least some of the operational steps shown in the blocks of each flowchart to be performed in parallel. Moreover, some of the steps may also be performed across more than one processor, such as might arise in a multi-processor computer system. In addition, one or more blocks or combinations of blocks in each flowchart illustration may also be performed concurrently with other blocks or combinations of blocks, or even in a different sequence than illustrated without departing from the scope or spirit of the invention.

Accordingly, each block in each flowchart illustration supports combinations of means for performing the specified actions, combinations of steps for performing the specified actions and program instruction means for performing the specified actions. It will also be understood that each block in each flowchart illustration, and combinations of blocks in each flowchart illustration, can be implemented by special purpose hardware-based systems, which perform the specified actions or steps, or combinations of special purpose hardware and computer instructions.

Further, in one or more embodiments (not shown in the figures), the logic in the illustrative flowcharts may be executed using an embedded logic hardware device instead of a CPU, such as, an Application Specific Integrated Circuit (ASIC), Field Programmable Gate Array (FPGA), Programmable Array Logic (PAL), or the like, or combination thereof. The embedded logic hardware device may directly execute its embedded logic to perform actions. In one or more embodiments, a microcontroller may be arranged to directly execute its own embedded logic to perform actions and access its own internal memory and its own external Input and Output Interfaces (e.g., hardware pins or wireless transceivers) to perform actions, such as System On a Chip (SOC), or the like. Additionally, the logic of the illustrative flow chart and described herein may be executed using a processor readable non-transitory storage medium for storing the instructions that cause the actions described herein, comprising one or more of a flash drive, a hard drive, a hard disk drive, a memory card, or the like.

The foregoing examples and descriptions should not be construed as limiting or exhaustive, but rather, an illustrative use case to show an implementation of at least one of the various embodiments.

1. A system, comprising:
a projection device that is arranged to emit one or more laser beams;
a spindle mirror mechanism (SMM) that includes a rotatable reflective surface that is configured to rotate around an axis to outwardly reflect the one or more laser beams;
a kaleidoscopic mirror with a plurality of facets (KMFs) in a concave arrangement around the SMM, wherein the plurality of KMFs are arranged to redirect the one or more reflected laser beams to create a virtual projector having a distinct virtual origin point and a sweep direction for each KMF;
a plurality of cameras arranged around the KMFs to detect one or more reflections of light from an object surface that is illuminated by the one or more redirected laser beams; and
one or more processors that execute instructions to cause actions, including:
obtaining a correspondence between the one or more detected light reflections and one or more identified virtual projectors based on timing information associated with each of the one or more detected light reflections; and
using calibration of one or more motions for the one or more virtual projectors and geometric arrangement of their periodic sweep patterns to characterize each of the one or more laser beams as a periodic function of time for movement of the one or more virtual projectors in a three-dimensional (3D) environment.

2. The system of claim 1, further comprising:
using a triangulation between an origin for each identified virtual projector origin and a position of each camera that detects the one or more light reflections to obtain 3D surface coordinates of the object surface, wherein a 3D representation of the object surface is obtained based on the 3D surface coordinates.

3. The system of claim 1, wherein the kaleidoscopic mirror includes:
an inner ring of partially transparent facets; and
an outer ring of non-transparent facets, wherein the inner ring of partially transparent facts is arranged to partially transmit the one or more reflected laser beams to the outer ring of non-transparent facets.

4. The system of claim 1, wherein the plurality of KMFs, further comprise:
a plurality of hinges that are coupled to the kaleidoscopic mirror, wherein an angle of each hinge changes based on a speed of rotation of the SMM.

5. The system of claim 1, further comprising:
one or more half mirrors that are configured in a folding arrangement to double a field of view for each camera by providing two or more perspectives for detection by a camera.

6. The system of claim 1, further comprising a rotational speed control that is used to operate the SMM within a range of speeds.

7. The system of claim 1, wherein the plurality of cameras, further comprise:
one or more event sensors that are configured to identify a time stamped event for each change in intensity of the one or more light reflections.

8. The system of claim 1, further comprising:
a beam splitter that is coupled to the projection device and arranged to generate two or more laser beams that are collimated.

9. The system of claim 1, further comprising:
a dual aperture that is arranged with a mirror relay for one camera to capture a stereoscopic view of the object surface.

10. The system of claim 1, wherein the one or more processors cause further actions, comprising:
using event data to calibrate measurement of an angle and a position for each virtual projector.

11. The system of claim 1, wherein the kaleidoscopic mirror further comprises:
one or more non-uniform sizes for one or more of the plurality of KMFs to obtain a wider coverage for the plurality of laser beams redirected at the object surface.

12. The system of claim 1, wherein the one or more processors cause further actions, comprising:
guiding movement of one or more tools based on one or more of the three dimensional surface coordinates or the three dimensional representation of the object surface.

13. The system of claim 1, wherein the one or more processors cause further actions, comprising:
obtaining a look up table (LUT) that includes one or more precalculated relative accuracy values for one or more pair combinations of a virtual projector and a camera.

14. The system of claim 1, wherein the plurality of KMFs, further comprise:
an octagonal shaped arrangement of eight KMFs and four cameras positioned behind four of the eight KMFs to create eight distinct strokes of redirected laser beams in separate compass directions.

15. The system of claim 1, wherein the plurality of KMFs, further comprise:
a hexagonal shaped arrangement of six KMFs and three cameras positioned behind three of the six KMFs to create six distinct strokes of redirected laser beams at 60 degree intervals.

16. The system of claim 1, wherein the plurality of KMFs, further comprise:
a rectangular shaped arrangement of four KMFs and four cameras positioned behind the four KMFs to create four distinct strokes of redirected laser beams with proportional durations based on a field of view aspect ratio.

17. A method, comprising:
employing a projection device to emit one or more laser beams;
reflecting the one or more laser beams by use of a spindle mirror mechanism (SMM) that includes a rotatable reflective surface that is configured to rotate around an axis;
redirecting the one or more reflected laser beams by use of a kaleidoscopic mirror with a plurality of facets (KMFs) in a concave arrangement around the SMM, wherein the plurality of KMFs are arranged to create a virtual projector having a distinct virtual origin point and a sweep direction for each KMF;
detecting one or more reflections of light from an object surface that is illuminated by the one or more redirected laser beams by use of a plurality of cameras arranged around the KMFs;
obtaining a correspondence between the one or more detected light reflections and one or more identified virtual projectors based on timing information associated with each of the one or more detected light reflections; and
using calibration of one or more motions for the one or more virtual projectors and geometric arrangement of their periodic sweep patterns to characterize each of the one or more laser beams as a periodic function of time for movement of the one or more virtual projectors in a three-dimensional (3D) environment.

18. The method of claim 17, further comprising:
using a triangulation between an origin for each identified virtual projector origin and a position of each camera that detects the one or more light reflections to obtain 3D surface coordinates of the object surface, wherein a 3D representation of the object surface is obtained based on the 3D surface coordinates.

19. The method of claim 17, further comprising:
guiding movement of one or more tools based on one or more of the three dimensional surface coordinates or the three dimensional representation of the object surface.

20. A non-transitory computer storage medium with instructions, wherein execution of the instructions by one or more processors causes actions, comprising:
employing a projection device to emit one or more laser beams;
reflecting the one or more laser beams by use of a spindle mirror mechanism (SMM) that includes a rotatable reflective surface that is configured to rotate around an axis;
redirecting the one or more reflected laser beams by use of a kaleidoscopic mirror with a plurality of facets (KMFs) in a concave arrangement around the SMM, wherein the plurality of KMFs are arranged to create a virtual projector having a distinct virtual origin point and a sweep direction for each KMF;
detecting one or more reflections of light from an object surface that is illuminated by the one or more redirected laser beams by use of a plurality of cameras arranged around the KMFs;
obtaining a correspondence between the one or more detected light reflections and one or more identified virtual projectors based on timing information associated with each of the one or more detected light reflections; and
using calibration of one or more motions for the one or more virtual projectors and geometric arrangement of their periodic sweep patterns to characterize each of the one or more laser beams as a periodic function of time for movement of the one or more virtual projectors in a three-dimensional (3D) environment.
